(19) United States
(12) Patent Application Publication
(10) Pub. No.: US 2007/0136289 A1
(43) Pub. Date: Jun. 14, 2007

(54) Lock elision with transactional memory

(75) Inventors: Ali-Reza Adl-Tabatabai, Santa Clara, CA (US); Jesse Fang, San Jose, CA (US); Anwar Ghuloum, Menlo Park, CA (US); Rick Hudson, Florence, MA (US); Brian Murphy, Beijing (CN); Bratin Saha, San Jose, CA (US); Tatiana Shpeisman, Menlo Park, CA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/304,509

(22) Filed: Dec. 14, 2005

(51) Int. Cl. G06F 17/30

(52) U.S. Cl. 707/8

(57) ABSTRACT

In a system comprising a transactional memory architecture, initiating a transactional memory based transaction and then, within the transaction, checking a lock and if the lock is free, executing a critical section.

### BACKGROUND

In concurrent computing systems, including particularly those that include multi-core processors or, alternatively, multiple processors, it is often necessary for concurrently executing processes to arbitrate entry into a critical section of a program. This is often because a program executing in the critical section is accessing a resource that may only be accessed exclusively and must exclude all other programs from simultaneous access.

Many methods are known for such arbitration. For example, programs may achieve mutual exclusion for a critical section using test-and-test-and-set (TTS) locks, or Reader_Writer locks, each well known in the art. For certain applications, alternatively, a queue based lock may be used. Queue based locks, as is well known, include Ticket locks, Mellor-Crummey Scott (MCS) locks and Craig, Landin, and Hagersten (CLH) locks. MCS and Ticket locks are described in, for example, J. M. Mellor-Crummey and M. Scott, Algorithms for Scaleable Synchronization on Shared Memory Multiprocessors, ACM Transactions on Computer Systems, vol. 9, no. 1, February 1991. CLH locks are described, for example, in Michael L. Scott and William N. Scherer III, Scalable Queue-Based Spin Locks with Timeout, in Proceedings of the eighth ACM SIGPLAN symposium on Principles and practices of parallel programming, pp 44-52, 2001.

A technique termed Speculative Lock Elision (SLE) may be used to reduce unnecessary serialization caused by concurrent processes that need to access the same lock-related variables or have to wait on the same lock queue. SLE dynamically removes unnecessary lock-induced serialization, relying on the property that locks do not always have to be acquired for a correct execution. Synchronization instructions such as those that test or set locks that are predicted to be unnecessary, are bypassed or elided. This allows multiple threads to concurrently execute critical sections protected by the same lock without having to actually acquire the lock. Misspeculation due to inter-thread data conflicts is detected using existing cache mechanisms and rollback is used for recovery. Successful speculative elision is validated and committed without acquiring the lock. See Ravi Rajwar and James R. Goodman, Speculative Lock Elision: Enabling Highly Concurrent Multithreaded Execution, Proceedings of the 34th International Symposium on Microarchitecture (MICRO), 2001. Currently known approaches to SLE are, however, limited to the elision of simple non queued locks such as TTS locks.

Transactional support in hardware for lock-free shared data structures using transactional memory is described in M. Herlihy and J. Moss, Transactional memory: Architectural support for lock-free data structures, Proceedings of the 20^{th} Annual International Symposium on Computer Architecture 20, 1993 (Herlihy and Moss). This approach describes a set of extensions to existing multiprocessor cache coherence protocols that enable such lock free access. Transactions using a transactional memory are referred to transactional memory transactions or lock free transactions herein.

### BRIEF DESCRIPTION OF THE DRAWINGS

FIG. 1 depicts a processor based system in one embodiment.

FIG. 2 depicts processing in one embodiment.

FIG. 3 depicts processing in one embodiment.

### DETAILED DESCRIPTION

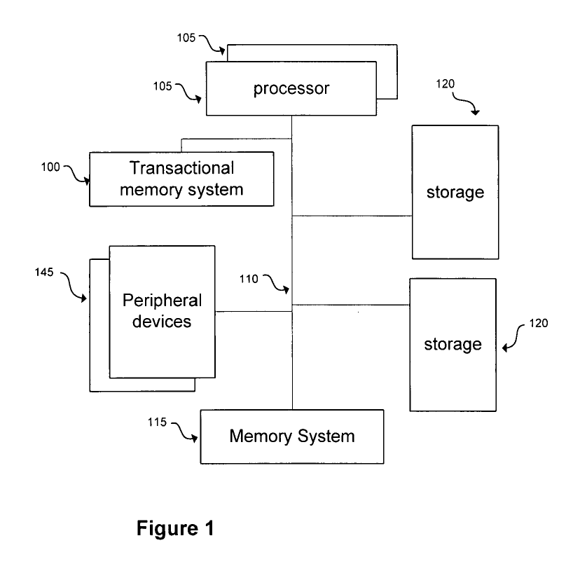

Referring to FIG. 1, a processor based system as shown may include one or more processors 105 coupled to a bus 110. Alternatively the system may have a processor that is a multi-core processor, or in other instances, multiple multi-core processors. In some embodiments the processor may be hyperthreaded, or able to perform in a manner as if it were a multi-core processor despite having only a single core. In a simple example, the bus 110 may be coupled to system memory 115, storage devices such as disk drives or other storage devices 120, peripheral devices 145. The storage 120 may store various software or data. The system may be connected to a variety of peripheral devices 145 via one or more bus systems. Such peripheral devices may include displays and printing systems among many others as is known.

In one embodiment, a processor system such as that depicted in the figure adds a transactional memory system 100 that allows for the execution of lock free transactions with shared data structures cached in the transactional memory system, as described in Herlihy and Moss. The processor(s) 105 may then include an instruction set architecture that supports such lock free or transactional memory based transactions. In such an architecture, the system in this embodiment supports a set of instructions, including an instruction to begin a transaction; an instruction to terminate a transaction normally; an instruction to abort a transaction.

The system of FIG. 1 is only an example and the present invention is not limited to any particular architecture. Variations on the specific components of the systems of other architectures may include the inclusion of transactional memory as a component of a processor or processors of the system in some instances; in others, it may be a separate component on a bus connected to the processor. In other embodiments, the system may have additional instructions to manage lock free transactions. The actual form or format of the instructions in other embodiments may vary. Additional memory or storage components may be present. A large number of other variations are possible.

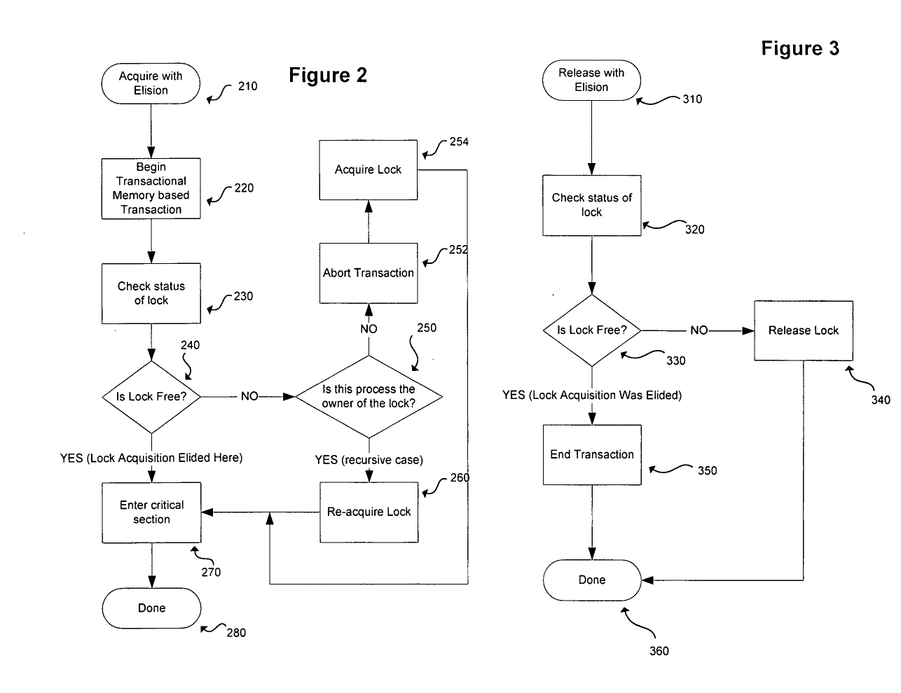

Transactional memory transactions provide a way to implement speculative lock elision for Reader-Writer locks, well known in the art, and for queue based locks such as CLH locks, Ticket locks and Mellor-Crummey Scott (MCS) locks, introduced above. FIG. 2 depicts at a high level the processing required in one embodiment to acquire a lock, with speculative elision. FIG. 3 depicts, at a high level, the processing required in the embodiment to release an elided lock. The processes shown are independent of the actual underlying locking mechanism, that is, they work for TTS, MCS, Ticket and other locks known in the art. In each case, the processing uses the properties of transactional memory based transactions.

Turning first to FIG. 2, an Acquire Lock with Elision process 210 begins by initiating a lock-free transaction at 220. Within the transaction, the process checks the lock at 230.

If the lock is not free at 240, then there are two possibilities. First, another process may actually be using the critical section and lock elision has to be abandoned. This is done by aborting the transaction, at 250, and then acquiring the lock or enqueuing the process in the lock acquisition queue, at 260 Once the lock has been acquired, the critical section may then be executed exclusively, 270, protected by the lock. On this path through the flow diagram (i.e. 240-250-252-254-270) the transaction is aborted at 250 to ensure correct atomic execution. This is because there may be other threads attempting to use the transaction and if the transaction is not aborted conflicts between such threads and the thread that has acquired the lock may go unnoticed.

It is possible for the Acquire Lock with Elision process to be invoked recursively, thus allowing recursive locking. There is no inherent limitation in the embodiment that prevents recursive locking from being correctly implemented. The path 240-250-260 in FIG. 2 is used in this instance. If at 240, the lock is not free, but at 250, the process that is executing is itself found to be the owner of the lock (self-owned lock), the process is recursive. In this case, it simply re-acquires the lock at 260 and enters the critical section.

If the lock is free at 240, then any other process using the critical section must also be in a transaction and so protected by the transactional memory mechanisms from undetected conflicts, and lock acquisition may be elided. The process in this case, simply enters the critical section at 270 and elides the lock acquisition step. As explained above, the atomicity of the transactional memory based transaction guarantees that if the transaction completes successfully, the critical section will have executed correctly without interference from other concurrent processes.

As indicated, the processing and the correctness of the processing in the figure are independent of the underlying lock mechanism involved in checking the status of the lock at 230 and in acquiring the lock at 260. In the case of a TTS lock, the step 230 may simply be a test of the test-and-set variable that comprises the TTS lock. In the case of an MCS, ticket or other queue based data structure implementing a lock, the test may require checking of a queue or other data structure. Similarly, the step 260 in which a lock is acquired may require the process to enter into a busy wait loop or block in the case of a TTS lock; alternatively it may need to enqueue itself in the case of an MCS, Ticket, or another queue based lock.

FIG. 3 depicts at a high level the processing required to release a lock with elision. In this instance, a process that has already completed an acquire with elision as in FIG. 2 first checks the status of the lock at 320. If the lock is not free, it means that the process had previously acquired it, and thus it is released at 340. If on the other hand, the lock is free, then the lock was previously elided and the process is still executing in a transaction which now needs to be terminated at 350. As before the underlying lock mechanism could be any of the ones described above, i.e. TTS, MCS, or Ticket, among others and the overall process as depicted in the figure remains the same.

Many variations on these above described embodiments are possible. As discussed above the embodiment described in FIGS. 2 and 3 may use a TTS, Ticket or MCS locking system. Other locking systems that are not described above may also be used, because in general most locking systems for synchronization have functionality that allows checking of the lock status, lock acquisition, and release. As indicated previously, the actual code implementing the transactional memory based transaction may vary widely, as may the underlying processor instructions that are invoke to begin, abort and end a transaction.

Table 1 is a C-like program in one embodiment in which a system that provides transactional memory based transaction provides an implementation of Ticket locks with elision. An implementation such as that outlined in Table 1 could allow existing programs that used ticket locks to use calls to the lock acquisition and release routines without changes to the calling program while the implementation defined in the table would provide transparent support for elision in the implementation of ticket locks.

```
TABLE 1
/***********************************************************
  * Ticket locks with lock elision
  ***********************************************************/
```

| | |
|---|---|
| 1. | typedef struct { |

| | |
|---|---|
| 2. | volatile uint32 nextTicket; |
| 3. | volatile uint32 nowServing; |
| 4. | volatile uint32 tid; |
| 5. | uint32 recursionCount; |

| | |
|---|---|
| 6. | } TicketLock; |

/* Acquire a ticket lock using speculative elision */

| 7. | void TicketLockAquireWithElision(TicketLock* lock) |
|---|---|
| 8. | { |
| 9. | if (TransactionBegin( ) == TransactionContinue) { |
| | /* we are in a transaction */ |

| | |
|---|---|
| 10. | if (lock−>nextTicket == lock−>nowServing) |

/* the lock is free, continue transactional execution */
/* nextTicket & nowServing are now in the
transaction read set */

| | |
|---|---|
| 11. | return; |

| | |
|---|---|
| 12. | else if (lock−>tid == myTid) { /* I am the owner */ |

| | |
|---|---|
| 13. | lock−>recursionCount++; |
| 14. | return; |

| | |
|---|---|
| 15. | } |
| 16. | else |

| | |
|---|---|
| 17. | TransactionAbort( ); |

| | /* abort transaction because lock was not free */ |
|---|---|
| 18. | } |
| | /* if we get here it means that the transaction was |
| | aborted |
| | acquire the lock and return, we are non speculative |
| | here |
| | and the lock acquire is also non speculative */ |
| 19. | TicketLockAcquire(lock); |
| 20. | return; |
| 21. | } |

/* Release a ticket lock */

| | |
|---|---|
| 22. | void TicketLockReleaseWithElision(TicketLock* lock) |
| 23. | { |

/* the lock can only be in 2 states. It is either free, which means
this thread executed transactionally, or it is acquired, in which
case the thread releases the lock normally */

| | |
|---|---|
| 24. | if (lock−>nextTicket == lock−>nowServing) |

| | |
|---|---|
| 25. | TransactionEnd( ); |

| | |
|---|---|
| 26. | else |

| | |
|---|---|
| 27. | TicketLockRelease(lock); |

| | |
|---|---|
| 28. | } |

The program shown in Table 1 essentially implements the flowcharts of FIGS. 2 and 3. For easy reference, the lines in the program are numbered. First, the code defines a typical Ticket lock data structure, TicketLock at lines 1-5. It then lists implementations of the functions to acquire a ticket lock with elision (TicketLockAcquireWithElision) and a function to release a ticket lock with elision (TicketLockReleaseWithElision). First considering the acquire function at lines 7-16, the call at line 8 to TransactionBegin( ) is a call to a transaction initiation transaction function to begin a lockless transaction. If the transaction initiation succeeds, the code at lines 9 and 10 is executed, otherwise execution reaches line 11 which handles the aborted transaction case. Line 9 is a check to see if the ticket lock is free using a standard check in the Ticket lick protocol, and if it is, the lock may be elided and the function returns at line 10. If the lick is not free, line 12 checks whether the lock was recursively acquired, and if so, line 13 increments the recursion count. Otherwise the transaction is aborted at line 17 and processing continues at line 19. Line 19 is executed in two cases: first, when the Transaction cannot be initiated, at line 8, and second, when the lock is not free, at line 16. In either case, the process invokes the standard lock acquire mechanism for Ticket locks which is not detailed here.

The symmetrical processing for lock release is then listed at lines 17-23. The program first checks the lock at line 19. If the lock is free, program has been executing within a transaction and the lock aquire was elided, and thus it ends the transaction at line 20. Otherwise, the lock is released at line 22.

Table 2 depicts similar processing when the lock is an MCS lock. As may be observed from the C code segment outline in the table, it is identical to Table 1 except that in this program, the lock is an MCS lock and the corresponding calls to check the lock for availability, acquire and release the lock are the corresponding MCS lock calls.

```
TABLE 2
/********************************************************
  * MCS locks with lock elision
  *******************************************************/
typedef struct {
```

| | |
|---|---|
| volatile MCSLockNode* next; | /* next waiter */ |

| | |
|---|---|
| volatile int locked; | /* 1 if lock |

acquired */
} MCSLockNode;
typedef struct {

volatile MCSLockNode* waiterQueueTail; /* new waiters are
added at

the tail of the queue */

uint32 tid;
int recursionCount;

} MCSLock;
/* Acquire an MCS lock using speculative elision */
void MCSLockAcquireWithElision(MCSLock* lock, MCSLockNode*
node)
{

if (TransactionBegin( ) == TransactionContinue) {

/* we are in a transaction */
if (lock−>waiterQueueTail == NULL)
/* the lock is free, continue transactional
execution */
/* waiterQueueTail is now in the transaction
read set */

return;

else if (lock−>tid == myTid) { /* I own the
lock */

lock−>recursionCount++;
return;

}
else

TransactionAbort( );

/* abort transaction because lock was not
free */

}
/* if we get here it means that the transaction was
aborted

acquire the lock and return, we are non
speculative here
and the lock acquire is also non speculative */

MCSLockAcquire(lock, node);
return;

}
/* Release an MCS lock */
int MCSLockReleaseWithElision(MCSLock* lock, MCSLockNode*
node)
{

/* the lock can only be in 2 states. It is either free, which
means this thread executed

transactionally, or it is acquired, in which case
the thread

releases the lock normally */
if (lock−>waiterQueueTail == NULL)

TransactionEnd( );

else

MCSLockRelease(lock, node);

}

As should be clear to one in the art, the tables above are merely exemplary code fragments in one embodiment. In other embodiments, the implementation language may be another language, e.g. C++ or Java, or another language; the variable names used may vary, and the names of all the functions accomplished by the programs listed above may be arbitrarily varied, without changing the input and output relationship, as is known.

In the preceding description, for purposes of explanation, numerous specific details are set forth in order to provide a thorough understanding of the described embodiments, however, one skilled in the art will appreciate that many other embodiments may be practiced without these specific details.

Some portions of the detailed description above are presented in terms of algorithms and symbolic representations of operations on data bits within a processor-based system. These algorithmic descriptions and representations are the means used by those skilled in the art to most effectively convey the substance of their work to others in the art. The operations are those requiring physical manipulations of physical quantities. These quantities may take the form of electrical, magnetic, optical or other physical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

In the description of the embodiments, reference may be made to accompanying drawings. In the drawings, like numerals describe substantially similar components throughout the several views. Other embodiments may be utilized and structural, logical, and electrical changes may be made. Moreover, it is to be understood that the various embodiments, although different, are not necessarily mutually exclusive. For example, a particular feature, structure, or characteristic described in one embodiment may be included within other embodiments.

Further, a design of an embodiment that is implemented in a processor may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) that constitute or represent an embodiment.

Embodiments may be provided as a program product that may include a machine-readable medium having stored thereon data which when accessed by a machine may cause the machine to perform a process according to the claimed subject matter. The machine-readable medium may include, but is not limited to, floppy diskettes, optical disks, DVD-ROM disks, DVD-RAM disks, DVD-RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, embodiments may also be downloaded as a program product, wherein the program may be transferred from a remote data source to a requesting device by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the claimed subject matter but to illustrate it. The scope of the claimed subject matter is not to be determined by the specific examples provided above but only by the claims below.

What is claimed is:

1. In a system comprising a transactional memory architecture, a method comprising:
initiating a transactional memory based transaction then,
within the transaction, checking a lock and
if the lock is free, executing a critical section

2. The method of claim 1 further comprising:
if the lock is not free, then aborting the transaction and acquiring the lock prior to
executing the critical section

3. The method of claim 2 further comprising
subsequent to executing the critical section,
if the lock is free, committing the transaction; and
if the lock is not free, releasing the lock

4. The method of claim 3 wherein the lock comprises a queue-based lock.

5. The method of claim 4 wherein the lock comprises one of
a Mellor-Crummey Scott (MCS) lock;
a Craig, Landin, and Hagersten (CLH) lock; and
a Reader-Writer (RW) lock.

6. The method of claim 3 wherein the lock comprises a ticket lock.

7. In a system comprising a transactional memory architecture, a method comprising:
initiating a transactional memory based transaction then,
within the transaction, checking a lock;
if the lock is free executing a critical section;
if the lock is not free, and the thread executing the transaction is not the current owner of the lock, then aborting the transaction and acquiring the lock prior to executing the critical section;
if the lock is not free, and the thread executing the transaction is the current owner of the lock, then recursively acquiring the lock prior to executing the critical section; and
subsequent to executing the critical section, if the lock is free, committing the transaction; and
if the lock is not free, releasing the lock

8. The method of claim 7 wherein the lock comprises a queue-based lock.

9. The method of claim 8 wherein the lock comprises one of
a Mellor-Crummey Scott (MCS) lock;
a Craig, Landin, and Hagersten (CLH) lock; and
a Reader-Writer (RW) lock.

10. The method of claim 7 wherein the lock comprises a ticket lock.

11. A machine readable medium having stored thereon a data that when accessed by a machine causes the machine to perform a method in a system comprising a transactional memory architecture, the method comprising:
initiating a transactional memory based transaction then,
within the transaction, checking a lock and
if the lock is free executing a critical section

12. The machine readable medium of claim 11 further comprising:
if the lock is not free, then aborting the transaction and acquiring the lock prior to executing the critical section

13. The machine readable medium of claim 12 further comprising
subsequent to executing the critical section,
if the lock is free, committing the transaction; and
if the lock is not free, releasing the lock

14. The machine readable medium of claim 13 wherein the lock comprises a queue-based lock.

15. The machine readable medium of claim 14 wherein the lock comprises one of
a Mellor-Crummey Scott (MCS) lock;
a Craig, Landin, and Hagersten (CLH) lock; and
a Reader-Writer (RW) lock.

16. The machine readable medium of claim 13 wherein the lock comprises a ticket lock.

17. A machine readable medium having stored thereon a data that when accessed by a machine causes the machine to perform, in a system comprising a transactional memory architecture, a method comprising:
initiating a transactional memory based transaction then,
within the transaction, checking a lock;
if the lock is free executing a critical section;
if the lock is not free, and the thread executing the transaction is not the current owner of the lock, then aborting the transaction and acquiring the lock prior to executing the critical section;
if the lock is not free, and the thread executing the transaction is the current owner of the lock, then recursively acquiring the lock prior to executing the critical section; and
subsequent to executing the critical section,
if the lock is free, committing the transaction; and
if the lock is not free, releasing the lock

18. The machine readable medium of claim 17 wherein the lock comprises a queue-based lock.

19. The machine readable medium of claim 18 wherein the lock comprises one of
a Mellor-Crummey Scott (MCS) lock;
a Craig, Landin, and Hagersten (CLH) lock; and
a Reader-Writer (RW) lock.

20. The machine readable medium of claim 17 wherein the lock comprises a ticket lock.

21. A system comprising a transactional memory architecture comprising:
a processor to execute programs, and further operable to
initiate a transactional memory based transaction;
commit a transactional memory based transaction; and
abort a transactional memory based transaction;
a memory;
a transactional memory architecture;
the processor to execute a program stored in the memory, the program, when executed to:
initiate a transactional memory based transaction then,
within the transaction, to check a lock;
if the lock is free, to execute a critical section;
if the lock is not free, then to abort the transaction and acquire the lock
prior to executing the critical section; and
subsequent to executing the critical section,
if the lock is free, to commit the transaction; and
if the lock is not free, to release the lock

22. The system of claim 1 wherein the memory comprises Dynamic Random Access Memory (DRAM).
